(19) United States
(12) Patent Application Publication
(10) Pub. No.: US 2007/0286445 A1
(43) Pub. Date: Dec. 13, 2007

(54) Microphone Assembly with Preamplifier and Manufacturing Method Thereof

(75) Inventor: James Steven Collins, Elk Grove Village, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/742,238

(22) Filed: Apr. 30, 2007

Related U.S. Application Data
(63) Continuation of application No. 10/809,984, filed on Mar. 26, 2004, now abandoned.

(51) Int. Cl. H04R 17/02

(52) U.S. Cl. 381/355

(57) ABSTRACT

A microphone assembly include a microphone housing unit having a cover and a base. The microphone assembly further includes a preamplifier circuit assembly attached to the base and protected by the cover. The protected preamplifier circuit assembly has at least one terminal unprotected by the cover. A radio frequency interference suppression device can be electrically coupled to the preamplifier circuit and includes at least one internal ground electrically coupled to the at least one terminal. The at least one internal ground provides a ground path between the cover and the base.

### TECHNICAL FIELD

This patent is a continuation of U.S. Ser. No. 10/809,984 filed Mar. 26. 2004, the disclosure of which is hereby expressly incorporated for all purposes.

This patent generally relates to microphones used in listening devices, such as hearing aids or the like, and more particularly, to a microphone assembly with preamplifier and a method of manufacturing the same.

### BACKGROUND

Hearing aid technology has progressed rapidly in recent years. Technological advancements in this field continue to improve the reception, wearing-comfort, life-span, and power efficiency of hearing aids. With these continual advances in the performance of ear-worn acoustic devices, ever-increasing demands are placed upon improving the inherent performance of the miniature acoustic transducers that are utilized. There are several different hearing aid styles known in hearing aid industry: Behind-The-Ear (BTE). In-The-Ear or All In-The-Ear (ITE), In-The Canal (ITC), and Completely-In-The-Canal (CTC).

Generally, a listening device, such as a hearing aid or the like, includes a microphone portion, an amplification portion and a receiver (transducer) portion. The microphone portion receives vibration energy, i.e. acoustic sound waves in audible frequencies, and generates an electronic signal representative of these sound waves. The amplification portion accepts the electronic signal., increases the electronic signal magnitude, and communicates the increased electronic signal (e.g. the processed signal) to the receiver portion. The receiver portion, in turn, converts the increased electronic signal into vibration energy for transmission to a user.

The electronic signals communicated from the microphone portion to the amplification portion, are susceptible to high frequency interference radiated, for example, in the range of 1-3 GHz. To reduce the sensitivity to low and high radio frequency interference signals (RFI). the conventional microphone assembly comprises a preamplifier assembly with capacitive couplings. In particular, the microphone portion can be communicatively coupled to the preamplifier assembly to reduce the RFI generated by communication devices such as cellular phones, web-enabled phones, personal digital assistants (PDAs). laptops, other devices that may be capable of communication over one or more public or private communication networks. Furthers microphone assemblies include external ground wirings or electrical paths to connect the portions of the microphone casing and further reduce the sensitivity to low and high radio frequency interference (RFI) signals. However, known microphone assemblies provide poor RFI suppression in the presence of a communication device such as cellular phone and thereby making the microphone assembly less attractive to potential customers. In addition, known microphone assemblies that provide acceptable RFI suppression often require additional, and costly assembly steps to connect and position ground wires between the individual external portions of the microphone casing.

### BRIEF DESCRIPTION OF THE DRAWINGS

For a more complete understanding of the invention, reference should be made to the following detailed description and accompanying drawings wherein:

FIG. 1 is a perspective view of a microphone assembly;

FIG. 2 is an exploded view illustrating a microphone assembly embodying the teachings of the present disclosure:

FIG. 3 is an enlarged exploded view of the microphone assembly shown in FIG. 2; and

FIG. 4 is a cross-sectional view of the microphone assembly of FIG. 2.

### DETAILED DESCRIPTION

While the present invention is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

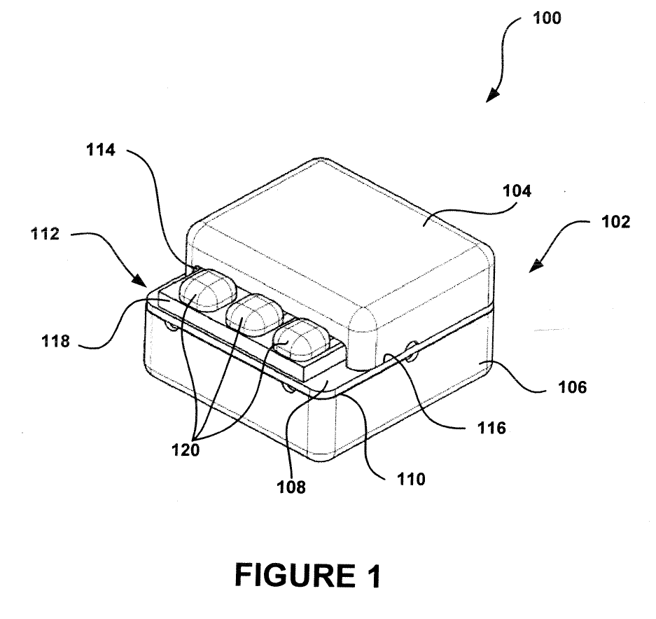

FIG. 1 illustrates a perspective view of a microphone assembly generally indicated by the numeral 100. The microphone assembly 100 includes a housing 102 having a cover 104 and a cup or base 106. The housing 102 can be manufactured in a variety of configurations such as, a roughly square shape, a cylindrical shape, a rectangular shape or any other desired geometry. In addition, the scale and size of the housing 102 may be varied based on the intended application, operating conditions, required components, etc. Moreover, the housing 102 can be manufactured from a variety of materials such as, for example, stainless steel, alternating layers of conductive materials, alternating layers of non-conductive materials (e.g., metal particle-coated plastics).

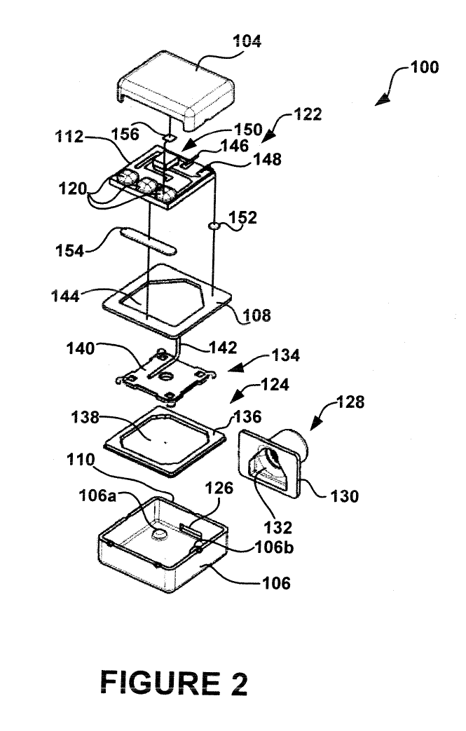

The microphone assembly 100 further includes a mounting frame 108 sized to engage a top edge 110 of the base 106. The mounting frame 108 supports a printed circuit board (PCB) 112. The mounting frame 108 may be a single layer of stainless steel, as shown, or may utilize alternating layers of conductive and/or non-conductive materials such as metal particle-coated plastics. Further, the mounting frame 108 may have various shapes and a number of different of sizes corresponding to the overall shape of the housing 102. The PCB 112 extends though an opening 114 formed in a bottom edge 116 of the cover 104. An exposed portion 118 of the PCB 112 supports a plurality of contact points or electrical connection terminals 120. The electrical connection terminals 120 provide an electrical connection to a preamplifier circuit assembly 122 shown in FIG. 2.

FIG. 2 illustrates an exploded view of the microphone assembly 100. The base 106 may include a plurality of supporting members 106a-106b to serve as a support for the diaphragm assembly 124. It will be understood that a variety of supporting structures such as a U-shaped plate, two deformed corners, or a glue fillet, may be utilized to support the diaphragm assembly 124.

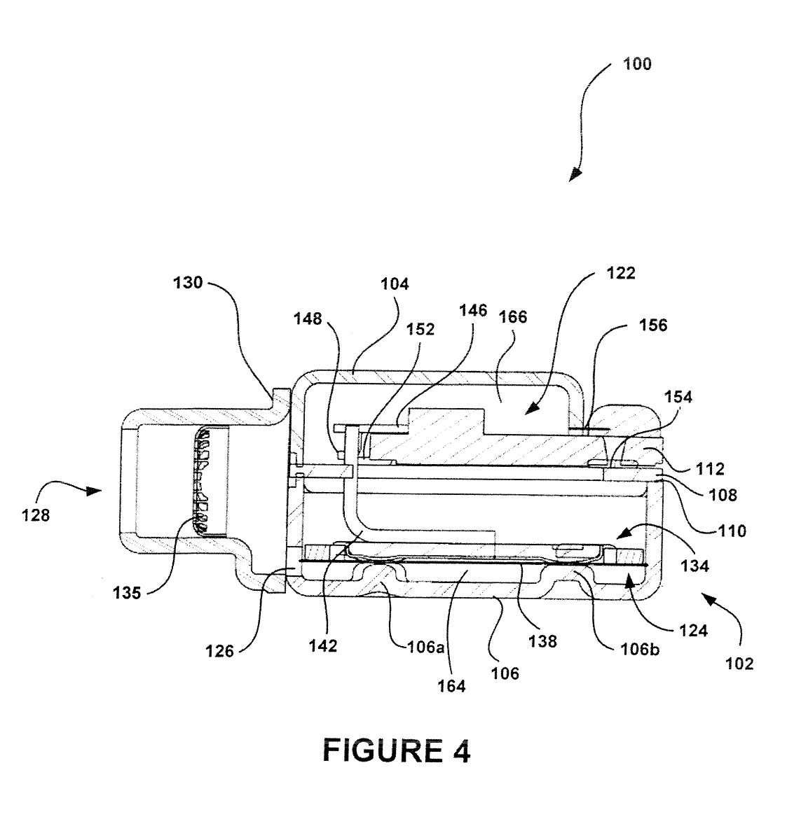

The base 106 further includes a sound inlet port 126 positioned distal to the top edge 110. A sound inlet tube 128 that includes a mounting plate 130 and a sound passage 132 can be positioned adjacent to the sound inlet port 126 to direct the received acoustic waves into the base 106. The mounting plate 130 secures the sound inlet tube 128 to the base 106. The mounting plate 130 can be fixedly attached using, for example, a glue or epoxy, or removably attached using any known fastener. The sound passage 132 provides an acoustic path to the sound inlet port 126. The sound passage 132 can be formed through the sound inlet tube 128 in any suitable manner such as drilling, punching or molding. A damping element or filter 135 (see FIG. 4) positioned within the sound passage 132 provides an acoustical resistance to the microphone assembly 100. In operation, sonic energy or acoustic waves enter the microphone assembly 100 via the sound passage 132. Thereafter, the sonic energy or acoustic waves communicates to the sound inlet port 126. The sound inlet tube 128, as discussed above in connection with the housing 102, can be manufactured from a variety of materials such as, for example, stainless steel, alternating layers of conductive materials, alternating layers of non-conductive materials (e.g., metal particle-coated plastics).

The microphone assembly 100 further includes a diaphragm assembly 124, and a backplate assembly 134. The shape of the diaphragm assembly 124 generally corresponds to the base 106 and mounting frame 108, but may take the form of the various shapes and sizes in different embodiments. The diaphragm assembly 124 includes a support plate 136 and a diaphragm 138 fixedly attached to the support plate 136. The diaphragm assembly 124 positioned within the base 106 and supported by the support members 106a, 106b.

The support plate 136 can consist of any electrically conductive material such as stainless steel, however, any material that includes a conductive coating may be utilized. The diaphragm 138 comprises an electrically conductive material or a thin polymer film peripherally attached to the bottom surface of the support plate 136.

The backplate assembly 134 may include a connecting wire 142 fixedly attached to a backplate 140. In particular, the connecting wire 142 attaches to a top surface the backplate 140 by, for example, bonding with adhesive. The connecting wire 142, in turn, extends through an opening 144 of the mounting frame 108 to electrically couple an input point 146 of the preamplifier assembly 122. In other words, the backplate assembly 134 and diaphragm assembly 124 are communicatively coupled to the preamplifier assembly 122 via the connecting wire 142 through the opening 144 to transmit and provide acoustic signals thereto.

The bottom surface of the backplate 140 can be plated with any polarized dielectric film or electret material such as, for example, TEFLON®. The plated backplate 140 forms a fixed electrode and is mounted by adhesive fillets (not shown) to the support plate 136 of the diaphragm assembly 124 and, in turn, to peripheral portions of the diaphragm 138. The dielectric film or electret material on the bottom surface of the backplate 140 cooperates with the diaphragm 138 to develop an acoustic signal. The resulting combination of the backplate assembly 134 and the diaphragm assembly 124 define an electret microphone portion. It will be understood that the operation of the microphone assembly 100 is generally based on the fixed electrode of the backplate assembly 140 and the movement of the diaphragm 138 in response to exposure to acoustic waves or sonic energy to generate a representative electrical signal.

The preamplifier assembly 122 may include a preamplifier such as, for example, a source-follower field effect transistor (FET) 150 integrated circuit. The preamplifier assembly 122 further includes the plurality of electrical connection terminals 120, the input point 146, the ground point 148, and the PCB 112. The PCB 112 electrically connects the plurality of electrical connection terminals 120 positioned external to the cover 104 with the FET 150 positioned internal to the cover 104. The preamplifier assembly 122, in turn, electrically connects to the mounting frame 108 by means of a conductive adhesive 152, 154. The conductive adhesives 152, 154 cooperate with a wire bonding 156 affixed within the housing 102 to effectively short-circuit RFI generated by nearby communication devices.

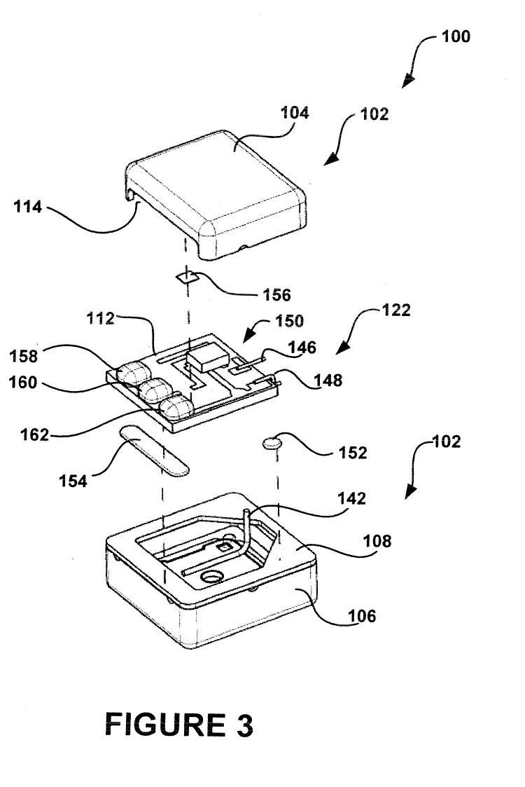

FIG. 3 illustrates an enlarged exploded view of the microphone assembly of FIG. 1. The backplate assembly 134 and the diaphragm assembly 124 are affixed adjacent to the support members 106a, 106b within the base 106. In particular, the backplate assembly 134 attaches to the diaphragm assembly 124, the resulting combination is, in turn, positioned opposite the opening 144 of the mounting frame 108. The mounting frame 108, the preamplifier assembly 122 and the cover 104 collectively constitute a back volume portion arranged to convert the electrical capacitance generated by the electret microphone portion to the acoustic signal indicative of the acoustic wave transmitted to the diaphragm assembly 124.

As discussed above, the preamplifier assembly 122 electrically connects via the input point 146 and the connecting wire 142 to the backplate assembly 134. Moreover, the preamplifier assembly 122 is grounded to the diaphragm 138 via the ground point 148, the mounting frame 108, and the base 106. The plurality of electrical connection terminals 120 can comprise an input connection 158, an output connection 160, and a ground connection 162. The input connection 158 supplies electric power to the preamplifier assembly 122. The input connection 158 and the output connection 160 are communicatively connected to an input (not shown) the preamplifier assembly 122. The ground connection 162 connects the ground point 148 to reduce the sensitivity to low and high radio frequency interference signals generated by communications devices such as, for example, cellular phones.

To further reduce the sensitivity to low and high radio frequency interference signals, the preamplifier assembly 122 connects to the base 106 via the mounting frame 108 by means of the conductive adhesive 152, 154 to ground the RFI signals caused by communications device. The cover 104 is, in turn, grounded to the preamplifier assembly 122 by the wire bond 156. Thus, the RFI present with the amplifier output signal supplied by the output connection 160 is suppressed.

The preamplifier assembly 122 can be a capacitively coupled circuit including the FET 150 adapted to reduce the RFI generated by communications devices. The circuit can further include an electrical ground path between the ground connection 162 and the cover 104 via the wire bond 156. The electrical ground path formed between the cover 104 and the ground connection 162 effectively short-circuits undesirable RFI generated by any nearby communication devices. The wire bond 156 fixedly connects to the opening 114 of the cover 104 using a conductive adhesive such as an epoxy with suspended metallic flakes. In particular, the conductive adhesive can be a two-part silver epoxy adhesive that provides high electrical conductivity and strong conductive bonding. Conductive adhesive can replace traditional tin lead (Sn—Pb) solder and can further act as an effective heat sink.

The preamplifier assembly 122 can further include a first resistance-capacitance network and a second resistance-capacitance network (not shown) communicatively connected to the FET 150. The first resistance-capacitance network connects to the ground point 148 by means of conductive adhesive 152 to suppress the undesirable RFI generated by nearby communication devices. The second resistance-capacitance network connects to the base 106 via the mounting frame 108 by means of conductive adhesive 154 to suppress the undesirable RFI generated by nearby communication devices.

FIG. 4 illustrates a cross-sectional view the exemplary microphone assembly 100. The diaphragm assembly 124 attaches within the base 106 adjacent to the sound inlet 126. The sound inlet port 126 is fluidly connected to a first side 164 of the diaphragm 138 to provide acoustic waves received through the sound inlet tube 128. The backplate assembly 134 mounts to the top surface the diaphragm assembly 124. As previously discussed, the backplate assembly 134 and the diaphragm assembly 124 constitute the electret microphone portion.

The mounting frame 108 mounts to the top edge 110 of the base 106 and supports the preamplifier assembly 122. The preamplifier assembly 122 attached to the mounting frame 108 by means of conductive adhesive 152, 154 to provide an electrical path to ground and thereby effectively short-circuit RFI generated by nearby communication devices.

The input point 146 of the preamplifier assembly 122 couples to the wire connection 142 of the backplate assembly 134 to provide an acoustic signal thereto. The preamplifier assembly 122 partially protrudes through the opening 114 of the cover 102 (as shown in FIG. 1) to provide electrical access to the plurality of electrical terminals 120 including the ground connection 162. The preamplifier assembly 122 is further grounded to the cover 104 by means of wire bonding 156.

The mounting frame 108, the preamplifier assembly 122 and the cover 104 collectively constitute a back volume portion 166 to convert the electrical capacitance generated by the electret microphone portion to the acoustic signal indicative of the acoustic wave transmitted to the diaphragm assembly 124. In other words, the diaphragm assembly 124 and the backplate assembly 134 electrically connect to the preamplifier assembly 122 through the connecting wire 142 to communicate the acoustic signal generated by the diaphragm 138.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone assembly comprising:
a microphone housing unit having a cover and a base.
a preamplifier circuit assembly fixedly attached to the base and protected by the cover, the preamplifier circuit assembly having at least one terminal unprotected by the cover; and
a radio frequency interference suppression device electrically coupled to the preamplifier circuit, wherein the radio frequency interference suppression device includes:
at least one internal ground electrically coupled to the at least one terminal, and wherein the at least one internal ground provides a ground path between the cover and the base.

2. The microphone assembly of claim 1 further comprising:
a mounting frame fixedly attached to the base and adapted to support the preamplifier circuit assembly.

3. The microphone assembly of claim 2, wherein the preamplifier circuit assembly is fixedly attached to the mounting frame using an adhesive.

4. The microphone assembly of claim 3, wherein the adhesive is a conductive material.

5. The microphone assembly of claim 2, wherein the adhesive includes a plurality of metallic flakes suspended therein.

6. The microphone assembly of claim 1, wherein the at least one internal ground includes a first internal ground communicatively coupled to the base, and a second internal ground communicatively coupled to the cover.

7. A microphone assembly comprising:
a microphone housing base adapted to support a diaphragm assembly within an interior;
a mounting frame fixedly attached to the microphone housing base and adapted to support a preamplifier circuit assembly having an external ground, wherein the preamplifier circuit assembly and the diaphragm assembly are electrically connected:
a microphone housing cover adapted to enclose the preamplifier circuit assembly;
a first internal ground electrically coupled to the microphone housing cover and the external ground; and
a second internal ground electrically coupled to the microphone housing base and the first internal ground, wherein the first internal ground and the second internal ground cooperate with the microphone housing base and the microphone housing cover to suppress radio frequency interference.

8. The microphone assembly of claim 6, wherein the preamplifier circuit assembly is electrically connected to the mounting frame using an adhesive.

9. The microphone assembly of claim 8, wherein the adhesive is a conductive material.

10. The microphone assembly of claim 9, wherein the adhesive includes a plurality of metallic flakes suspended therein.

11. A transducer assembly comprising:
a housing having a cover and a base, the housing defining an interior and an exterior;
a transducer assemble operatively disposed within the interior;
a mounting frame assembly secured to the base, and at least partially disposed within the interior;
a preamplifier circuit assembly coupled to the mounting frame assembly, the preamplifier circuit assembly having at least one terminal disposed on the exterior, and the preamplifier circuit assembly being electrically coupled to receive an output of the transducer; and
at least a first ground path, the first ground path electrically, conductively coupling the preamplifier assembly, the mounting frame and the base.

12. The transducer assembly of claim 11, wherein the mounting frame comprises a conductive portion, the conductive portion forming a portion of the first ground path.

13. The transducer assembly of claim 11, comprising a second ground path electrically, conductively coupling the preamplifier assembly to the cover.

14. The transducer assembly of claim 11, comprising a second ground path electrically, conductively coupling the terminal, the mounting frame and the preamplifier assembly.

15. The transducer assembly of claim 14, wherein the mounting frame comprises a conductive portion, and the conductive portion forming a portion of the second ground path.

16. The transducer assembly of claim 11, comprising a second ground path electrically, conductively coupling the preamplifier assembly to the cover and a third ground path electrically, conductively coupling the terminal, the mounting frame and the preamplifier assembly.

17. The transducer assembly of claim 16, wherein the mounting frame comprises a conductive portion, and the first ground path and the third ground path each comprise the conductive portion.

18. The transducer assembly of claim 11, wherein the preamplifier circuit assembly is fixedly attached to the mounting frame using a conductive adhesive, the conductive adhesive forming a portion of the first ground path.

19. The transducer assembly of claim 11, wherein the mounting frame is fixedly attached to the base using a conductive adhesive, the conductive adhesive forming a portion of the first ground path.

20. The transducer assembly of claim 11, the first ground path comprising at least one solder connection.

21. The transducer assembly of claim 11, the first ground path being disposed in the interior.

22. A transducer assembly comprising:
a housing having a cover and a base, the housing defining an interior and an exterior;
a transducer assembly operatively disposed within the interior:
a mounting frame assembly secured to the base;
a preamplifier circuit assembly coupled to the mounting frame assembly, the preamplifier circuit assembly having at least one terminal exposed externally of the housing, and the preamplifier circuit assembly being electrically coupled to receive an output of the transducer; and
a first ground path, the first ground path electrically, conductively coupling the preamplifier assembly, the mounting frame and the base, a second ground path electrically, conductively coupling the preamplifier assembly to the cover and a third ground path electrically, conductively coupling the terminal, the mounting frame and the preamplifier assembly.

23. The transducer assembly of claim 22, wherein the mounting frame comprises a conductive portion, and the first ground path and the third ground path each comprises the conductive portion.

24. The transducer assembly of claim 22, wherein the preamplifier circuit assembly is fixedly attached to the mounting frame using a conductive adhesive, the conductive adhesive forming a portion of each of the first and the third ground paths.

25. The transducer assembly of claim 22, wherein the mounting frame is fixedly attached to the base using a conductive adhesive, the conductive adhesive forming a portion of each of the first and the third ground paths.

26. The transducer assembly of claim 22, any one of the first ground path, the second ground path or the third ground path comprises at least one solder connection.

27. The transducer assembly of claim 22, at least one of the first ground path, the second ground path or the third ground path being disposed in the interior.

28. The transducer assembly of claim 22, the first ground path and the third ground path being disposed in the interior.
